(19) United States
(12) Patent Application Publication
(10) Pub. No.: US 2015/0124109 A1
(43) Pub. Date: May 7, 2015

(54) APPARATUS AND METHOD FOR HOSTING A LIVE CAMERA AT A GIVEN GEOGRAPHICAL LOCATION

(71) Applicant: Arben Kryeziu, Kahului, HI (US)

(72) Inventor: Arben Kryeziu, Kahului, HI (US)

(21) Appl. No.: 14/071,726

(22) Filed: Nov. 5, 2013

(51) Int. Cl. H04N 5/232

(52) U.S. Cl. CPC H04N 5/23206
USPC 348/211.3

(57) ABSTRACT

A camera network comprising a plurality of cameras located at one or more locations is disclosed. A server receives real-time video data stream from multiple cameras, wherein the server hosts a web service to display thumbnails associated with each camera, wherein the server continuously prerecords a first predefined duration of the video data received from the multiple cameras. A user uses the web service to select a camera. Then, the user initiates recording of the video data stream received from the selected camera and the web service records a second predefined duration of the video. Finally, the web service combines the prerecorded first predefined duration of the video received from the selected camera and the second predefined duration of the video to obtain a third video.

### FIELD OF THE INVENTION

The present invention relates to cameras connected to computer networks and, more particularly, relates to systems, apparatuses, and methods for providing access to a distributed network of cameras.

### BACKGROUND OF THE INVENTION

Real-time video is considered the next big thing for the internet. Live visual communication is the closest that technology can take us to the real location of action. Although the Internet originated as a way to share data and text, it quickly supported cameras called “webcams,” that is, cameras connected to the Internet.

Businesses have started using cameras to allow users to view live images of various physical locations, such as hotels, amusement parks, beaches, parks, retail stores, and sports stadiums. Often business use an array of cameras networked with multiple computers showing various views of a facility. A user may access a video streamed by a camera by visiting a website that contains a link to remote webcams available over the Internet. However, currently businesses need to invest in technology that will help manage the video streamed by their cameras. Since video streaming involves heavy bandwidth requirement, this often leads to various problems. In addition, users often want to record and share live events from the video streamed by the cameras. For example, a user may witness a shark attack on a video streamed by a camera installed on a beach. By the time, the user starts recording the video, they miss recording at least a part of the shark attack. The current technology also allows users to navigate through remote physical locations by remotely controlling a camera to pan, zoom or tilt to alter the view captured by the camera. However, businesses with cameras on their premises may want to restrict the movement of the camera. For example, a hotel owner may want to restrict camera movement such that the camera does not capture view of a swimming pool. Often cameras lack the ability to restrict such movements.

In light of the foregoing, a need exists for a system that provides camera owners to easily provide live video feeds to their customers and to restrict movements of the camera. The system also enables users to fully record live events they witness on a video streamed by a camera. The present invention, in certain embodiments, achieves these objectives and others.

### SUMMARY

A camera network comprising a plurality of cameras located at one or more locations is disclosed. At least one server receives real-time video data stream from the plurality of cameras, wherein the at least one server hosting a web service to display thumbnails associated with each camera in the plurality of cameras, wherein the at least one server is continuously prerecording a first predefined duration of the video data received from at least one camera in the plurality of cameras. There is at least one user using the web service to select a thumbnail associated with a camera in the plurality of cameras to view the video data streamed from the selected camera. Next, the at least one user initiating recording of the video data stream received from the selected camera. The web service records a second predefined duration of the video in response to the at least one user initiating the recording. Finally, the web service combines the prerecorded first predefined duration of the video received from the selected camera and the second predefined duration of the video to obtain a third video.

### BRIEF DESCRIPTION OF THE DRAWINGS

FIG. 1 illustrates a camera network in accordance with an embodiment of present disclosure.

FIG. 2 illustrates an interface of a web service in accordance with an embodiment of the present disclosure.

FIG. 3 is a flow diagram illustrating an exemplary method for accessing the web service in accordance with the present disclosure.

FIG. 4 illustrates an exemplary camera network for allowing users to control the cameras in accordance with the present disclosure.

FIG. 5 illustrates an exemplary camera network for allowing users to control the cameras in accordance with the present disclosure.

FIG. 6 illustrates a table of a database that is maintained by the web service in accordance with an embodiment of the present disclosure.

FIG. 7 depicts an exemplary camera network for allowing users to control the cameras in accordance with the present disclosure.

### DETAILED DESCRIPTION OF ILLUSTRATIVE EMBODIMENTS

The following detailed description discloses aspects of the claimed invention and the ways it can be implemented. However, the description is not intended to define or limit the invention, such definition or limitation being solely contained in the claims appended thereto. Although the best mode of carrying out the invention has been disclosed comprehensively, those in the art would recognize that other embodiments for carrying out or practicing the invention are also possible.

The present disclosure unveils a new and useful camera network. With the disclosed network, a user can view as well as record special moments captured in a live camera video stream. However, by the time a user initiates recording, the moment he was hoping to record might be missed. Therefore, the network prerecords a predefined duration of the video data streamed from a camera. This helps the user to get a recording of complete live event. The user may then share the video on social media sites (e.g., Facebook®, Twitter®, Google+®, Vimeo®, and YouTube®). Further, the recorded videos may be included in an online video stock repository.

### Camera Network

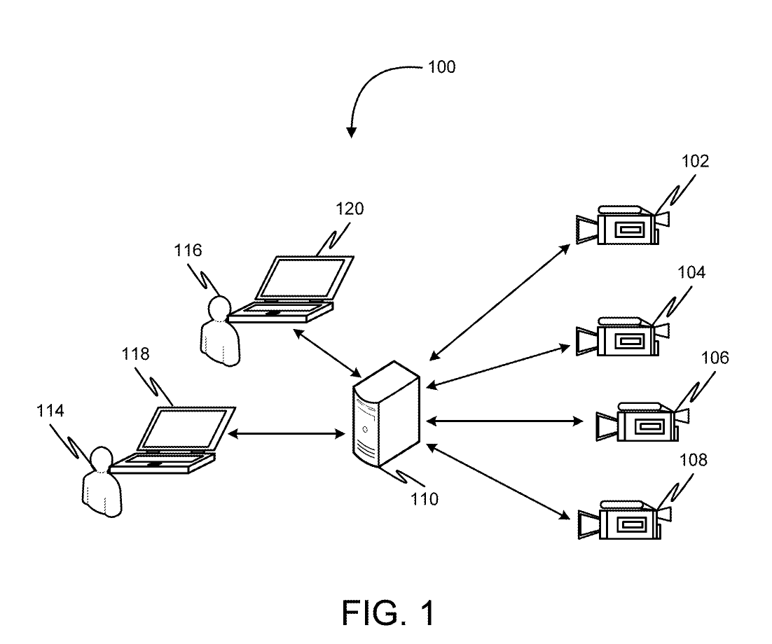

FIG. 1 illustrates a camera network 100 in accordance with an embodiment of present disclosure. The camera network 100 includes of a plurality of cameras 102, 104, 106 and 108 located at one or more locations. The cameras 102-108 may be webcams, Internet Protocol (IP) cameras, Pan-Tilt-Zoom (PTZ) cameras, and more. The cameras 102-108 may support different camera drivers, wherein each driver can have different specifics in the structure, protocol, video data format, meta-data, etc. Further, the cameras 102-108 may be connected to one or more servers 110 through a wired or wireless connection or network; for example, a cable network, a Wide Area Network (WAN), a Municipal Area Network (MAN), a Local Area Network (LAN), the Internet, an Intranet, or any combination of the above. They may be positioned in such a way that they can easily focus on a specific predefined area. The cameras 102-108 may produce a consistent real-time video data stream that is almost similar to the actual view of the location that a person sees when physically present there. Each camera 102, 104, 106 and 108 produces a continuous stream of digital video signals made up of frames, wherein a frame is one of the many still images that make a moving picture or a video. The cameras 102-108 may stream videos at Standard-Definition (SD) resolution or a High-Definition (HD) resolution.

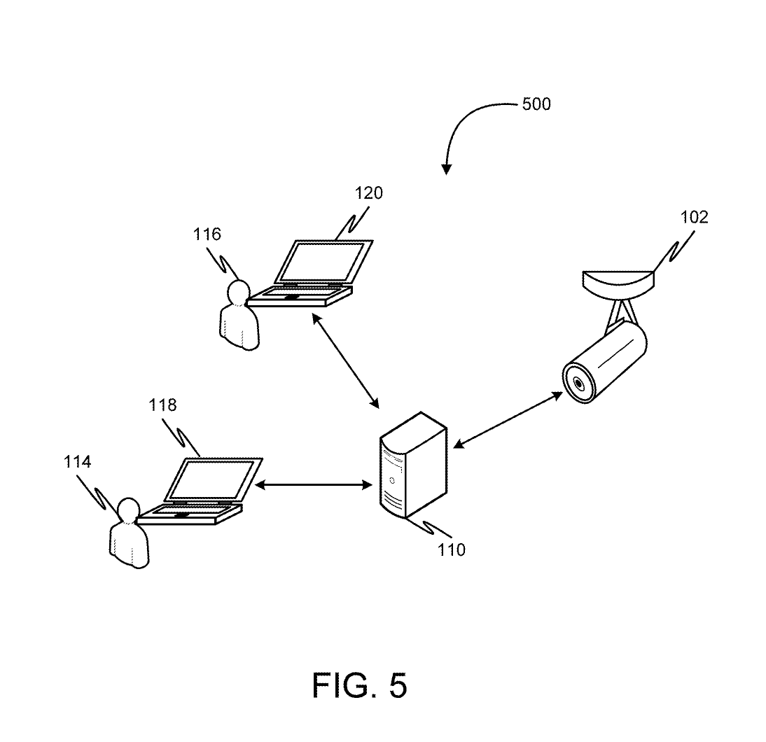

The camera network 100 may include one or more servers 110. The one or more servers 110 may pull one video data stream from each camera and multiply the video data stream to allow unlimited number of users to view the streamed video. The one or more servers 110 host a web service 112 to provide access to the cameras 102-108. The users 114 and 116 may access the web service 112 using their electronic communication devices 118 and 120. The electronic communication devices 118 and 120 may be smartphones, tablets, desktop computers, etc. Further, a database at the one or more servers 110 may store data related to the cameras 102-108 and the users related to the web service 112. This is explained in further detail in conjunction with FIG. 5 below. Further, the one or more servers 110 may be cloud servers and the web service 112 may be a cloud application.

The one or more servers 110 may include: a controller; a data storage device operatively connected to the controller, wherein the data storage device contains information and photo images from the plurality of cameras 102-108; and a program stored on the data storage device and run on the controller, wherein the program is created to receive information from a user and further adapted to control the camera, download required video to the user computer and other such activities.

The video data stream received from the cameras 102-108 may be stored within the one or more servers 110 to form an online stock repository. Interested users may buy the videos from the online stock repository; for example, for commercial purposes such as advertising.

In an embodiment, users may add one or more new cameras to the camera network 100. Further, the web service 112 allows the users to embed real-time video data stream obtained from a camera 102-108 on their web-platforms. For example, a business (such as a hotel) may add a new camera on the camera network 100 to show its facilities, such as reception area and a restaurant. In addition, the hotel may embed the real-time video data stream obtained from the new camera on its website, such that visitors to its website can view the hotel facilities in real time. Further, the hotel may use the cameras for security or management purposes.

### Web Service Interface

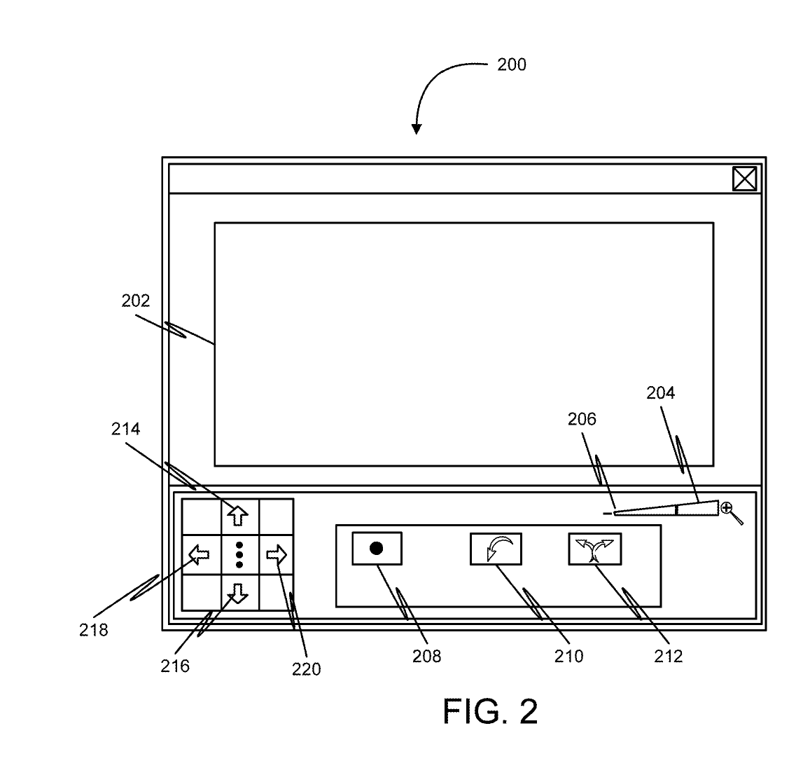

FIG. 2 illustrates an interface 200 of the web service 112 in accordance with an embodiment of the present disclosure. The users 114 and 116 may access the interface 200 to control the cameras 102-108. The web service 112 provides the same user interface 200 and a same user experience across various types of electronic communication devices, such as desktop computers, tablets, and smart phones. Further, the users 114 and 116 may use the interface 200 to record and share the live event on a social media platform. The social media platform may include Facebook®, LinkedIn®, Google+®, YouTube®, Ning®, Twitter®, MySpace®, and Orkut®. Further, the interface 200 may be accessed through an Internet browser or a software application on the electronic communication devices 118 and 120. The Internet browser may be one of Google Chrome®, Mozilla Firefox®, AOL®, Internet Explorer®, Netscape Navigator®, Dolphin®, Opera®, Safari®, etc. The software application may be a desktop application or a smartphone application. The desktop application is a computer application that is compatible with desktop computer Operating System (OS), such as OS Microsoft Windows®, Linux®, and iOS®. The smartphone application may be one of an iPhone® application, iPad® application, Android® application, BlackBerry® application, BlackBerry tablet® application, webOS® application, Symbian® application, bada® application, Windows® application, and Maemo® application.

Further, the interface 200 includes various icons and buttons corresponding to different functions that may be used by the users 114 and 116. The interface 200 also includes a viewing area 202 that displays thumbnails associated with each camera in the plurality of cameras. The thumbnail displayed for a particular camera may be obtained from the received video data stream for the respective camera. The users 114 and 116 may select a thumbnail associated with a camera to view the video data streamed from the selected camera. Further, the viewing area 202 may display real-time video data stream received from the selected camera. The interface 200 also includes a zoom-in button 204 and a zoom-out button 206, which may be activated to zoom in or zoom out for a graphics image/video displayed on the viewing area 202. When the zoom-in button 204 or the zoom-out button 206 is activated, the web service 112 may use digital zoom to magnify by cropping the image and up-sampling the cropped portion. In an alternate embodiment, the web service 112 may send a command signal to the respective camera to perform optical zoom to magnify the video using lenses of the camera.

A record button 208 allows the users 114 and 116 to record the video. Further, a download button 210 may be used to download the recorded videos and a share button 212 may be used to share recorded videos on various social media platforms. The one or more servers 110 continuously prerecord a first predefined duration of the video data received from the camera 102. Therefore, at any given time, the one or more servers 110 have a recording of the video data received from the camera 102 in the first predefined duration before the given time For example, if the first predefined duration is 10 seconds, then, at any given time, the one or more servers 110 have a recording of the last 10 seconds of the video data received from the camera 102. Hereinafter, this prerecorded video is referred to as a first video. The first predefined duration of the video for each camera may be recorded and stored in one or both of the cameras 102-108 and the one or more servers 110. When the users 114 and 116 initiate recording of the video data stream received from the selected camera, the web service 112 starts recording a second predefined duration of the video to obtain a second video. Finally, the web service 112 adds the second video to the first video to obtain a third video.

In an exemplary embodiment, the first predefined duration may be defined as 30 seconds and the second predefined duration may be defined as 90 seconds. Therefore, the one or more servers 110 prerecord 30 seconds of real-time video data stream received from the camera 102 to obtain a first video. A user may view a live video from the camera 102 located on a beach. Then the user may activate the record button 216 to record any event captured on the camera 102, such as a shark near a beach. In response to the actuation of the record button 216, the web service 112 will start recording the second predefined duration of the video for 90 seconds to obtain a second video. Finally, the web service 112 will obtain the first video for 30 seconds from the cache and add it to the second video to obtain a third video of 120 seconds.

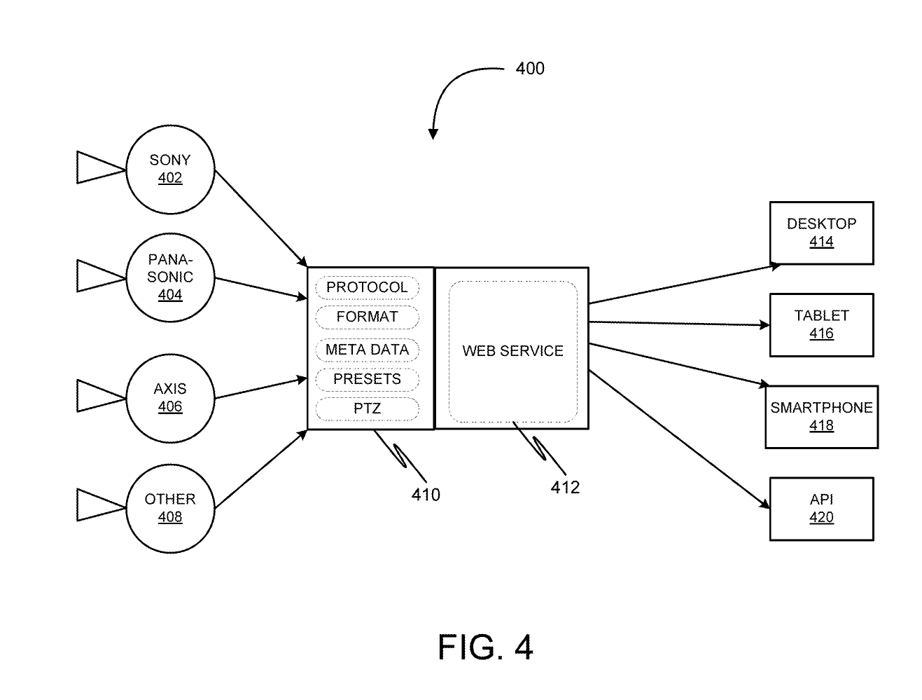

The interface 200 may further include an up button 214, a down button 216, a left button 218, and a right button 220, which when activated by the users 114 and 116 moves the viewpoint of the camera upward, downward, toward left side, and toward right side, respectively. Therefore, the buttons 218 and 220 help in panning the cameras 102-108 and the buttons 214 and 216 help in tilting the cameras 102-108. In another embodiment, the cameras 102-108 may be controlled by using a mouse, a joystick or a touch pad. This has been explained in detail in conjunction with FIG. 4 below.

Further, the web service 112 includes a security layer that helps in the authentication mechanism. It may also provide data security, data integrity and data confidentiality services. For example, the security layer may allow users to restrict the zoom areas or movements (pan/tilt) areas when they add a new camera to the camera network 100. Users may restrict zoom areas or movement areas for privacy concerns. For example, a PTZ camera located in a hotel may be restricted such that it does not zoom in on a view that shows swimming pool. Certain PTZ camera systems are capable of restricting the viewing area. The security layer enables similar capability for other cameras. Further, the security layer may restrict access to a camera such that users need security information to perform at least one of the following: viewing the video, controlling the camera, recording videos, and sharing videos.

The web service 112 also maintains user accounts for the users 116 and 118 accessing the web service 112. The user accounts may contain personal information of the users including name, address, and email. Further, the user account of each user contains information about the amount of virtual currency (denoted by “ozos”) present in the user account. Virtual currency is electronic money that may be used to purchase paid services available on the web service 112. Therefore, the user account may be debited by a predetermined amount of ozos, when the paid services are used by the users 114 and 116. The ozos may also be purchased on the web service 112 by paying real currency. Further, the amount of remaining ozos gets continuously updated as per user activity. The information about the user activity may be stored in a database on the one or more servers 110. This is explained in detail in conjunction with FIG. 5 below. The user activity may include the time spent by the users, the number of videos recorded, the number of videos shared on the social media platforms. For example, if a user spends 20 minutes accessing the web service 112, this may help him earn ‘X’ ozos. In addition, if the user shares a recorded video on any of the social media platforms, this may help him earn ‘Y’ ozos. The paid services include extending the first and second predefined duration of the video, purchasing videos recorded by other users, removing advertisement from the recorded videos, and controlling a camera for longer durations.

### Method to Access the Camera Network

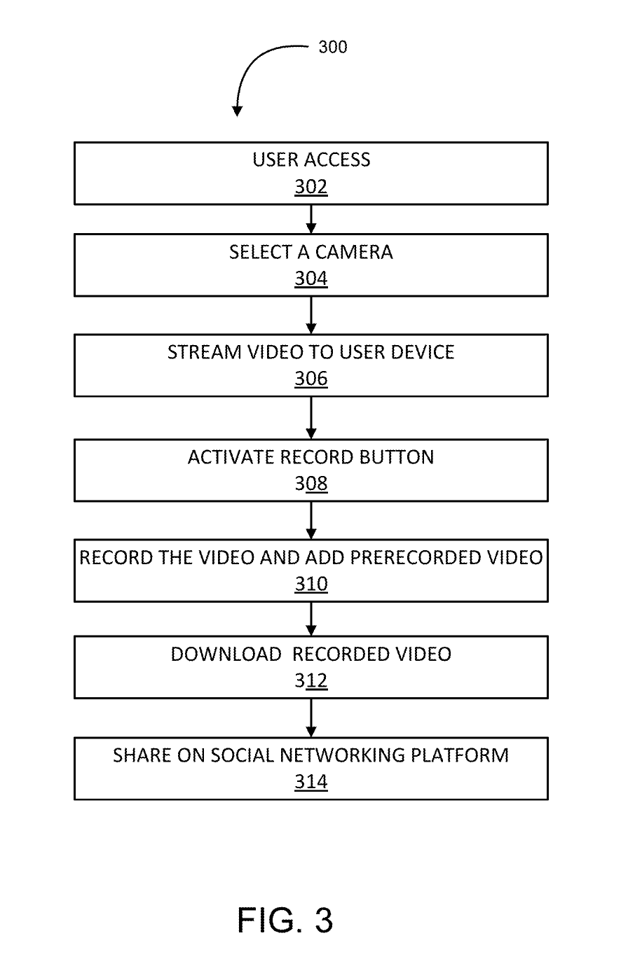

FIG. 3 is a flow diagram illustrating an exemplary method 300 for accessing the web service 112 in accordance with the present disclosure. At step 302, the user 114 accesses the web service 112. The user 114 may access the web service 112 through a website, a smartphone application or a desktop application using the user interface 200. The user interface 200 may also display live videos from the cameras 102-108. For example, the videos may be organized on the interface 200 in the form of thumbnails. Further, the thumbnails may be categorized according to the geographic locations of the cameras, types of activities captured, etc. Thereafter, the user 114 may select a camera 102 to view a live event at step 304. Next, at step 306, the web service 112 streams the video data from the camera 102 to the electronic communication device 118. The web service 112 may provide additional information along with the video streamed from the camera 102, wherein the additional information includes at least one of an advertisement and detailed live weather information about the location of the camera 102. The interface 200 may further include one of a chat room and a bulletin board that allows the users 114 and 116 to discuss the live events and recorded videos.

At step 308, while viewing the video, the user 114 activates the record button 208 to record a live event. However, by the time the user 114 activates the record button 208, the moment he was hoping to record may have gone by and the user may not be able to record the event. Therefore, the web service 112 keeps on prerecording a first predefined duration of the video from the camera 102 in a cache. The cache may be located in the camera 102 or the one or more servers 110. Further, a second predefined duration of the video is recorded, after the user 114 initiates recording. Finally, the web service combines the first predefined duration of the video before the second predefined duration of the video to obtain a complete third video at step 310. Thereafter, at step 312, the user may download the recorded video. The user may then share the recorded video on any social media platform at step 314.

### Camera Relay Network

FIG. 4 illustrating an exemplary camera network 400 in accordance with the present disclosure. The camera network 400 includes a plurality of cameras 402-408 and one or more servers 410 including a web service 412. A plurality of users may access the web service 412 using a plurality of electronic communication devices, including a desktop computer 414, a tablet 416, and a smart phone 418. Some users may use an API 420 provided by the web service 412 to access the video streamed from the plurality of cameras 402-408.

The one or more servers 410 form a relay network that attaches to each camera 402-408 as a single client. The relay network pulls in one feed from each of the cameras 402-408 and then allows an unlimited number of users to access the video. The relay network requires low minimum upstream bandwidth, which reduces infrastructure costs and outages. Further, the relay network supports different camera drivers. Each camera in the plurality of cameras 402-408 may be of a different make, and therefore, may have drivers that have different specifics in the structure, protocol, format, meta data (such as geo location), and presets. For example, the camera 402 is made by Sony, the camera 404 is made by Panasonic, and the camera 406 is made by Axis. The relay network also manages video transcoding, instant camera controls, image quality management, and branding and security of the video feed.

The camera owners may connect their cameras to the relay network to provide live videos to their customers. The relay network service provider may offer metered billing plans such that camera owners pay for the used resources only. Moreover, the relay network provides improved security by eliminating unauthorized camera access. The Camera IP address also remains private, which provides additional security against hackers. The camera owners may remotely control the setting of their accounts, including viewing real-time online viewer and bandwidth usage statistics.

The web service 412 delivers the same user experience across multiple delivery solutions, including the desktop computer 414, the tablet 416, the smartphone 418, or the API 420. The web service 412 provides a transparent delivery to the user, without changing the universal player experience. For example, the web service 412 may use H.264 compression for all the HD videos. The web service 412 outputs transcoded Flash-based video, which is accessed by users using a flash movie player. Therefore, users need not install any plug-ins to view the videos. The player is compatible with any standard web-browsers PC or MAC and mobile devices. The web service 412 also supports user controlled Pan, Tilt, Zoom, and fixed IP cameras.

Further, the web service 412 includes one or more video channels. A video channel streams video data received from a specific camera based on predefined schedule. The relay network service provider may specify time schedules for different cameras. Moreover, the users may switch the camera to a different camera or an on-demand/prerecorded video loop or static image or a slideshow.

### Controlling the Cameras

FIG. 5 illustrates an exemplary camera network 500 for allowing users to control the cameras in accordance with the present disclosure. The camera 102 is a PTZ camera capable of remote direction and zoom control. Multiple requests may be received by the web service 112 at the same time to control the camera 102. The multiple requests may be made by multiple electronic communication devices 118 and 120. When the web service 112 receives multiple requests to get control of the camera 102, the web service 112 assigns the camera to one of the users. The web service 112 may assign the camera 102 based on first-come-first-served policy, such that the user 114 gets access to control the camera 102 for a predefined duration of time; meanwhile, other users who request for camera control are in a first in, first out (FIFO) queue. Alternatively, the web service 112 may assign the camera 102 according to the priority of the user 114. The priority of each user may be calculated according to the user activity and stored in the user's account. In addition, the user 114 may pay a predetermined amount of ozos to control the camera 102 for longer durations or to move up the queue. During the control process, the control commands from the user device 118 are relayed through the Internet to the camera 102.

### Database

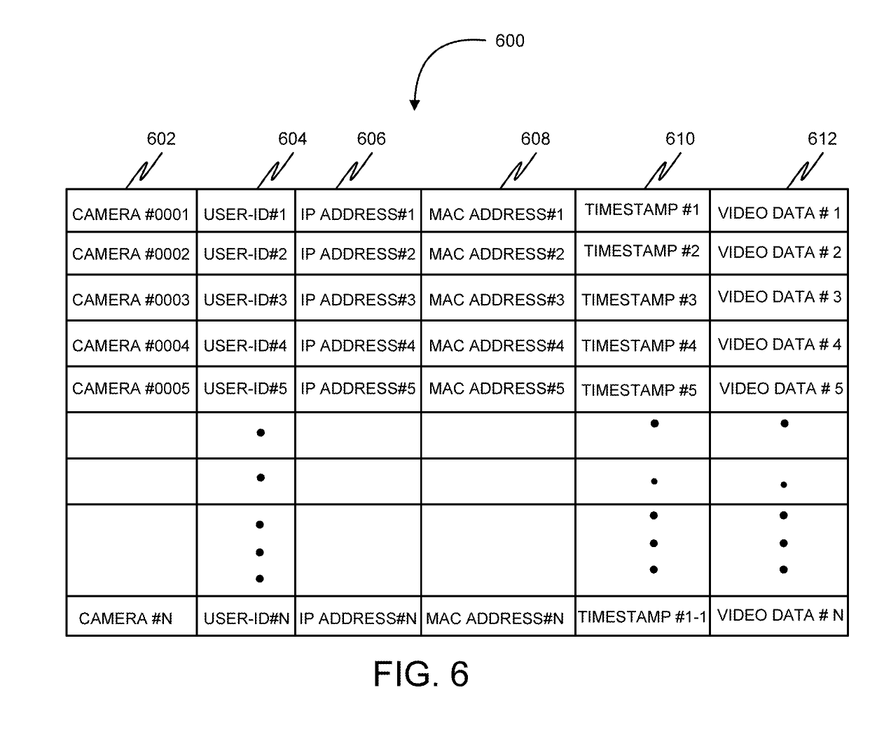

FIG. 6 illustrates a table 600 of a database that is maintained by the web service 112 in accordance with an embodiment of the present disclosure. The table 600 includes columns 602-612 which include information related to different parameters related to the users of the web service 112 and the cameras in the camera network 100. The table 600 may store camera-ID (column 602), the user ID (column 604), Internet Protocol (IP) Address (column 606), media access control (MAC) address (column 608), timestamp (610), and video data (612). The camera-ID may be an identification number of the camera. The user information may include personal information of the users 114 and 116, such as name, address, e-mail-ID, and contact number. The timestamps are the sequence of characters identifying when a certain event occurred, usually giving date and time of day. The events may include a user requesting control of a specific camera and a user viewing video data streamed from a specific camera.

### Application of Camera Network in a Sports Stadium

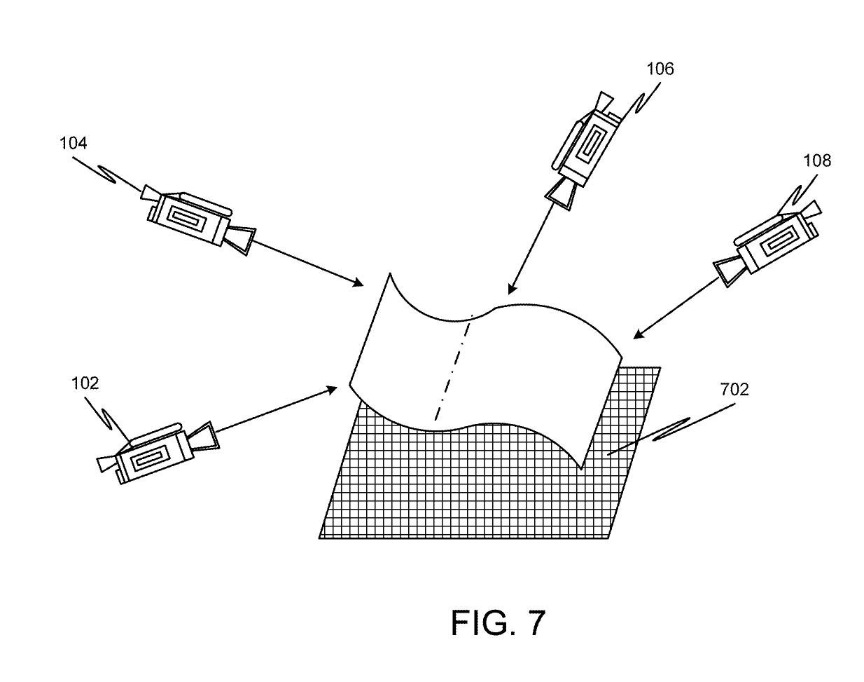

FIG. 7 depicts an exemplary embodiment of the camera network 100 in accordance with some embodiments of the present disclosure. The plurality of cameras 102-108 may be positioned around a stadium to capture a live baseball match. The cameras 102-108 may focus on various positions in the stadium, such as the baseball ground 702 and team dugouts. By following the steps explained in the FIGS. 3-5 above, the remote user 114 may get access to the cameras 102-108. Further, the user 104 may use different control commands, such as Zoom in/Zoom out, Pan, and Tilt to view specific areas on the ground 702. For example, the user 114 may focus the camera 102 on his favorite player, record the video, and share it on Facebook®.

Further, the user 114 may spend ozos to get access to the paid features of the web service 112. For example, the user 114 may use paid features to extend the duration of recording video.

Web service 112 may also give detailed live weather information about the location. Weather information may include temperature, humidity, precipitation, and wind speed. For example, a camera 102 may be located on a beach and a user 114 may want to go surfing. The user 114 may check the web service 112 for weather information on the beach before leaving home.

The present disclosure may be used by business owners to boost the attractiveness of any website by adding live video to capture the visitor's attention. Further, specific business, such as tourism, may show live-streaming images from tourist resorts on a website. In addition, construction industry may use the disclosed technology to view construction activity in real time.

It will be appreciated that several of the above disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A camera network, comprising:
a plurality of cameras located at one or more locations;
at least one server receiving real-time video data stream from the plurality of cameras, wherein the at least one server hosting a web service to display thumbnails associated with each camera in the plurality of cameras, wherein the at least one server continuously prerecording a first predefined duration of the video data received from at least one camera in the plurality of cameras;
the at least one user using the web service to select a thumbnail associated with a camera in the plurality of cameras to view the video data streamed from the selected camera;
the at least one user initiating recording of the video data stream received from the selected camera;
the web service recording a second predefined duration of the video in response to the at least one user initiating the recording; and
the web service combining the prerecorded first predefined duration of the video received from the selected camera before the second predefined duration of the video to obtain a third video.

2. A camera network of claim 1, wherein the first predefined duration of the video streamed by a camera is recorded and stored in at least one of the camera and the at least one server.

3. A camera network of claim 1, wherein at least one third party adds at least one new camera to the plurality of the camera using the web service, wherein the web service receives video data stream from the at least one new camera and displays a thumbnail associated with the received video data stream.

4. The camera network of claim 1, wherein the at least one server is a cloud server and the web service is a cloud application.

5. The camera network of claim 1, wherein the at least one server forms a relay network.

6. The camera network of claim 1, wherein the at least one server pulls one video data stream from a camera and multiplies the data stream to allow unlimited users to view the video.

7. The camera network of claim 1, wherein the at least one user performs at least one of downloading the third video and sharing it on at least one social media platform, wherein the at least one social media platform includes Facebook®, LinkedIn®, Google+®, YouTube®, Ning®, Twitter®, MySpace®, and Orkut®.

8. The camera network of claim 1, wherein the web service provides an interface that comprises user selectable options to perform one or more of zooming the video, panning the camera, tilting the camera, recording the video, and sharing the recorded video.

9. The camera network of claim 1, wherein the at least one server comprises a security layer to provide data security, data integrity, and data confidentiality services.

10. The camera network of claim 9, wherein the security layer enables users to restrict zoom areas or movements areas of a camera, wherein the security layers enables users to restrict access to a camera such that the users need security information to perform at least one of viewing the video, controlling the camera, recording videos, and sharing videos.

11. The camera network of claim 9, wherein control commands are relayed over from the users' device to the at least one server relay service and then forwarded to the camera.

12. The camera network of claim 1, wherein the web service receiving multiple requests from the two or more users to control the live camera, wherein the web service assigning the camera to a user in the two or more users for a predefined duration.

13. The camera network of claim 1, wherein the web service maintaining user accounts for the one or more users, with each user account holding information about the amount of virtual currency available in the user account, wherein the at least one user pays virtual currency to purchase paid services available on the web service, wherein at least one user purchases virtual currency by paying real currency to the web service, wherein the user account is credited with virtual currency based on the activity of the user.

14. The camera network of claim 1, wherein the paid services include extending the first predefined duration of the video and the second predefined duration of the video, purchasing videos recorded by other users, removing advertisement from the recorded videos, and controlling a camera for longer durations.

15. The camera network of claim 1, wherein the at least one server includes a database that maintains information about the user activity of each user, the information about the user activity includes the time spent by the users, the number of videos recorded, and the number of videos shared on social networking platforms.

16. The camera network of claim 1, wherein the web service provides additional information along with the video streamed from a camera, wherein the additional information includes at least one of detailed live weather information about the location of the respective camera and an advertisement, wherein the web service interface comprises one of a chat room and a bulletin board for users to discuss live events and recorded videos.

17. The camera network of claim 1, wherein the recorded videos are included in an online video stock repository, wherein users buy the recorded videos from the online stock repository.

18. A camera network, comprising:
a plurality of cameras located at one or more locations;
at least one server receiving real-time video data stream from the plurality of cameras, wherein the at least one server hosting a web service to display thumbnails associated with each camera in the plurality of cameras, wherein the at least one server continuously prerecording a first predefined duration of the video data received from at least one camera in the plurality of cameras;
the at least one user using the web service to select a thumbnail associated with a camera in the plurality of cameras to view the video data streamed from the selected camera;
the at least one user initiating recording of the video data stream received from the selected camera;
the web service recording a second predefined duration of the video in response to the at least one user initiating the recording; and
the web service combining the prerecorded first predefined duration of the video received from the selected camera and the second predefined duration of the video to obtain a third video;
wherein the web service provides an interface that comprises user selectable options to perform one or more of zooming the video, panning the camera, tilting the camera, recording the video, and sharing the recorded video, wherein the at least one server comprises a security layer to restrict zoom areas or movement areas on the relay service;
wherein the web service receiving multiple requests from the two or more users to control the live camera, wherein the web service assigning the camera to a user in the two or more users for a predefined duration

19. The camera network of claim 18, wherein the web service provides additional information along with the video streamed from a camera, wherein the additional information includes at least one of detailed live weather information about the location of the respective camera and an advertisement, wherein the web service interface comprises one of a chat room and a bulletin board for users to discuss live events and recorded videos.
